(19) United States
(12) Patent Application Publication
(10) Pub. No.: US 2023/0131868 A1
(43) Pub. Date: Apr. 27, 2023

(54) PROCESS AND A PLANT

(71) Applicant: CLEAN TEQ WATER TECHNOLOGY PTY LTD, Notting Hill, Victoria (AU)

(72) Inventors: Nikolai Zontov, Notting Hill, Victoria (AU); Peter Voigt, Notting Hill, Victoria (AU); Liann Goh, Notting Hill, Victoria (AU); Volha Yahorava, Notting Hill, Victoria (AU)

(21) Appl. No.: 17/798,113

(22) PCT Filed: Feb. 12, 2021
(86) PCT No.: PCT/AU2021/050125

§ 371 Date: Aug. 8, 2022

(30) Foreign Application Priority Data
Feb. 12, 2020 (AU) 2020900384

(51) Int. Cl. C02F 1/42; C02F 1/66; C02F 3/34; B01J 41/05; B01J 41/12; B01J 49/57

(52) U.S. Cl. CPC C02F 1/42; C02F 1/66; C02F 3/34; B01J 41/05; B01J 41/12; B01J 49/57; C02F 2101/163

(57) ABSTRACT

The present invention relates to a process and plant for treating feed water containing nitrate. The process includes, sorbing nitrate from the feed water onto an ion exchange resin to form a loaded resin and produce a treated water stream depleted in nitrate, regenerating the loaded resin so that the resin can be reused and produce a brine stream high in nitrate; and converting nitrate in the brine stream into molecular nitrogen gas with the assistance of a bioactive agent.

### FIELD OF THE PRESENT INVENTION

The present invention relates to a process and a plant for treating feed water. In particular, the present invention includes removing nitrate from the feed water and converting the nitrate removed from the feed water into nitrogen gas.

### BACKGROUND OF THE INVENTION

Drinking water and wastewater treatment facilities are facing a critical concern over nitrate levels in sources of drinking water and in effluent disposed to the environment. Nitrate is a health concern in drinking water and causes eutrophication of water bodies when wastewater effluents are high in nitrate.

Nitrate has traditionally been controlled in drinking water sources using ion exchange. Nitrate specific resins have been developed which capture and concentrate nitrate generally in exchange for chloride. These resins are regenerated using salt and the spent regenerant is normally disposed to sewer. Regulations have recently been enacted in many regions of the world limiting the salt load permitted to be discharged to sewer. This has led to many ion exchange plants ceasing operation and the subsequent closure of many drinking water sources.

Nitrate in wastewater is traditionally controlled by the biological process of denitrification. In wastewater treatment plants, a specific section of the plant is dedicated to the removal of nitrate directly from the wastewater. Again, regulations are being tightened on the levels of nitrate permitted to be discharged to the environment. In many instances, the wastewater treatment plants are unable to meet these tightened specifications, especially those in cold climates where biological activity is depressed by low temperatures.

The present invention is aimed at alleviating these problems.

### SUMMARY OF THE INVENTION

The present invention relates to a process of treating a feed water stream containing nitrate, the process includes the steps of:
i) sorbing nitrate in the feed water stream onto an ion exchange resin, which changes the ion exchange resin into a loaded ion exchange resin and produces a treated water stream depleted in nitrate;
ii) regenerating the loaded resin by desorbing nitrate therefrom using a regenerating stream including a salt which changes the loaded ion exchange resin into a regenerated ion exchange resin for reuse in step i), and produces a brine stream high in nitrate;
iii) converting nitrate in the brine stream into molecular nitrogen gas with the assistance of a bioactive agent, the nitrogen separates from the brine stream, and thereby forms a brine that provides a recycle stream; and
iv) adding at least part of the recycle stream to the regenerating stream.

In other words, the bioactive agent is used to lower the nitrate content of the brine stream, which allows the brine stream to be used as a recycle stream which can be used to form at least part of regenerating stream. The present invention is also based on the realisation that the bioactive agent can be used to convert nitrate to nitrogen gas in the brine stream while the brine stream is relatively high in salt.

An advantage of the process is that the salt content of the brine stream can be retained in the recycle stream which can then be added to the regenerating stream. This in turn minimises the need to discharge a brine that is high in salt to the environment, which is typical of conventional ion exchange processes.

In addition, the bioactive agent assists in converting the nitrate in the brine stream into molecular nitrogen which is inert and can be released to the atmosphere. Moreover, after the converting step, any residual nitrate in the brine is less likely to interfere in the regeneration of the ion exchange resin which enables the brine to be used as recycle stream. If the nitrate was not converted in accordance with the converting step, the brine could not be used as recycle stream as the nitrate interferes with the regeneration of the ion exchange resin.

The regenerated ion exchange resin may be reused in the step of sorbing nitrates.

A majority of the recycle stream may be added to the regenerating stream.

All of the recycle stream may be added to the regenerating stream.

The step of sorbing nitrates onto the resin may also sorbs sulphate onto the resin.

The process may also include taking a purge stream from, and adding a make-up stream to, at least one or a combination of the brine stream and the recycle stream to control the concentration of sulphate in the brine stream and/or the recycle stream. This will in turn also control the sulphate concentration in the regenerating step and the converting step.

Taking the purge stream and adding the make-up stream can control the sulphate ions accumulating in the brine stream and/or the recycle stream below a concentration: for example below a sulphate concentration of 10,000 mg/L; in another example below a sulphate concentration of 8,000 mg/L; in another example below a sulphate concentration of 6,000 mg/L; in another example below a sulphate concentration of 4,000 mg/L; in another example below a sulphate concentration of 2,000 mg/L; in another example below a sulphate concentration of 1,000 mg/L; in another example below a sulphate concentration of 500 mg/L; or in another example below a sulphate concentration of 200 mg/L. The concentration to which the sulphate concentrate can be allowed to reach will depend on the economics of handling the purge stream including disposal of the purge stream, for example, in sewage.

The feed water for the process can be from many sources simultaneously or separately and includes, but is not limited to, groundwater, surface water, municipal and industrial wastewater and municipal and industrial treated effluents. As such, the feed water stream could have any nitrate (as N) concentration, even as high as several hundred of mgs/L. In one example, the feed water stream may have a nitrate (as N) concentration in the range of the 1 to 1000 mg/L, and the treated water stream may have nitrate (as N) concentration in the range of 0.1 to 0.9 mg/L. In another example, the nitrate (as N) concentration in the feed water stream may be in the range of 50 to 600 mg/L, and the treated water stream may have a nitrate (as N) concentration in the range of 8 to 20 mg/L, and suitably in the range of 10 to 15 mg/L.

In another example, the feed water stream may have nitrate (as N) concentration in the range of 6 to 20 mg/L and the treated water stream may have nitrate (as N) concentration in the range of 0.1 to 5 mg/L. In another example, the feed water stream may have a nitrate (as N) concentration in the range of 8 to 12 mg/L and the treated water stream may have a nitrate (as N) concentration in the range of 0.5 to 2 mg/L. In another example, the feed water stream may have a nitration concentration of 10 mg/L, and the treated water stream may have a nitrate (as N) concentration of approximately 1 mg/L.

The step of converting nitrate in the brine stream into molecular nitrogen may include controlling pH so that the pH of the recycle stream is in the range of 5 to 10, and more ideally in the range of 6 to 8.

For example, the step of converting the nitrates in the brine stream may include adding an acid to lower the pH of the recycle stream discharged from converter step to a pH in the range of 5 to 9, and more ideally to a pH in the range of 6 to 8.

The denitrification of nitrate in the brine has a number of competing influences including high salinity, high nitrate (as N) concentration and a lack of nutrients which limit the effectiveness of a biological reaction of the bioactive agent. Without wanting to be limited by theory, the bioactive agent can denitrify the brine stream by reducing nitrate (NO₃⁻) to nitrite (NO₂⁻) which produces alkaline conditions, and nitrite is further reduced to molecular nitrogen with the assistance of controlling the pH, such as adding an acid.

The step of converting the nitrate in the brine solution may also include adding an electron donor to the brine stream. The electron donor may be any suitable donor such as carbonaceous material.

In one example, the carbonaceous material may be any suitable organic material such as is acetic acid which can be used either alone or in combination with one or more of: ethanol, glucose or sucrose. One advantage in using acetic acid is that is can act as an electron donor as well as aiding in the control of the pH of the brine stream. By controlling the pH and adding an electron donor to the brine solution, the bioactive agent is able to convert nitrate to the molecular nitrogen in accordance with the following equation:

2NO₃⁻+10e⁻+12H⁺ [symbol] N₂+6H₂O Equation 1:

The process may also include adding nutrients to the brine stream in the converting step to help support the longevity of the bioactive agent. The nutrients may include phosphate and some trace metals and minerals.

The bioactive agent may be any suitable denitrifying bacteria. An example is Paracoccus denitrificans.

The bioactive agent may be encapsulated in an inert body. The inert body may be made of any suitable material through which the brine stream can diffuse and entraps the bioactive agent. Ideally, the inert body has a porous inner region which contains the bioactive agent and an outer skin which retains the bioactive agent in the inner region.

The porous inner region and the outer skin of the inert body may have any polymeric structure, such as PVA (polyvinyl alcohol).

The process may also include a filtering step in which the recycle stream is filtered to remove solid materials prior to the recycle stream being added to the regenerating stream. The solid materials may include organic material, inorganic material, synthetic material and dissolved constituents.

The filtering step may include any one or a combination of physical filtering for removing particles from the recycle stream, such as sand filtering, cartridge filtering, sieves, and chemical filtering for removing dissolved organics and minerals. An example of a filter that can be used as a chemical filter is activated carbon. The filtering step may produce a solid phase, such as sludge that is separated from the recycle stream.

The ion exchange resin may be any suitable resin. Ideally, the resin would be a strong base anionic resin which has good selectivity to nitrate exchange. The anionic resin may be in the chloride form. The resins may be based on a polystyrenic or polyacrylic matrix with either gel or macroporous structures. An example of a suitable resin is a Type II resin which are at present commercially available.

The step of sorbing the nitrate onto the exchange resin includes nitrate being loaded onto the resin in exchange for an anion, for example, chloride ions. Other anions such as sulphate may also load onto the resin during the sorbing step.

The step of sorbing nitrate onto the exchange resin includes contracting the feed water stream and the ion exchange resin. Preferably, the feed water stream and the ion exchange resin move in a counter current mode while sorbing the nitrate.

Ideally, the salt of the regenerating stream that regenerates the loaded ion exchange resin has an anion that displaces the nitrate from the ion exchange resin to form the regenerated ion exchange resin. The anion may be any suitable anion. An example of a suitable anion is chloride ions.

The regenerated ion exchange resin may be reused in the sorbing step, i.e., step i).

The process may include adding the make-up stream to the regenerating stream. The term “make-up” indicates that additional anion is being introduced into the process for the first time.

The make-up stream may include a suitable alkali salt.

The alkali salt used for regenerating the loaded exchange resin may be a chloride salt, such as sodium chloride.

The step of adding a make-up anion may include adding sodium chloride to the regenerating stream so that the regenerating step has a sodium chloride concentration in the range of 1 to 12 wt %. Suitably the sodium chloride concentration is in the range of 2 to 8 wt %.

The regenerating step may include a first regenerating step in which the majority of sulphate is desorbed from the loaded resin and a second regenerating step in which the majority of the nitrate and any remaining sulphate is desorbed from the resin after the first regenerating step.

The regenerating step may include the first and second regenerating steps when, for example, the brine stream has a sulphate ion concentration of greater than 10,000 mg/L. Suitably, the regenerating step may include the first and second regenerating steps when the brine stream has a sulphate ion concentration of greater than 5,000 mg/L. Even more suitably, the regenerating step may include the first and second regenerating steps when the brine stream has a sulphate ion concentration of greater than 2,000 mg/L. Moreover, while the nitrate in the brine stream is removed by the bioactive agent, sulphate in the brine stream has the potential to accumulate in the recycle stream, even with some purging from the process. At some point, the concentration of sulphate, for example, at a concentration of greater than 2,000 mg/L could inhibit the ability of the bioactive agent to reduce the nitrate to nitrogen gas, and have potential to effect the resin regeneration. When the concentration of sulphate is below this concentration, the regenerating step may be carried out as a single regenerating step in which both nitrate and sulphate are desorbed together.

The first regenerating step may include contacting the loaded resin with a first regenerating stream that has a first anion concentration at the start of the first regenerating step to form a partially regenerated resin, and the second regenerating step may include contacting the partially regenerated resin with a second regenerating stream that has a second anion concentration at the start of the second regenerating step to fully regenerate the resin, wherein the first anion concentration is less than the second anion concentration. The sulphate has less affinity for the resin and the majority of sulphate can be selectively desorbed from the resin in the first regenerating step without desorbing a majority of the nitrate.

The type of anions of the first regenerating stream and the second regenerating stream that displace the sulphate and nitrate are ideally the same. Suitably chloride anions.

The first regenerating step may include diluting the first regenerating stream so that anion of the first regenerating stream is approximately 35%, and suitably 25% of the concentration of the anion in the recycle stream.

The process may include splitting the recycle stream into a first split stream and a second split stream, and the first split stream is diluted to reduce the concentration of the anion to form a first regenerating stream, and the first regenerating step includes contracting the first regenerating stream with the loaded resin to selectively desorb a majority of the sulphate from the resin, and form a partially regenerated resin. The first regenerating step can selectively desorb a majority of the sulphate without effectively desorbing the nitrate.

The second regenerating stream may include contacting the second split stream with the partially regenerated resin to fully regenerate the resin. In this situation, the second split stream may be a split of the recycle stream without being diluted.

The first regenerating stream may have an alkali salt concentration of less than or equal 2 wt % and the second regenerating stream may have an alkali salt concentration of greater more than 2 wt %.

Suitably, the first regenerating stream has an alkali salt concentration of approximately 1 wt %. Suitably the second regenerating stream has an alkali salt concentration of approximately 4 wt %.

The alkaline salt may be any alkali chloride, such as sodium chloride.

One or more of the sorbing step, the regenerating step and the converting step may be carried as either continuous flow stages, or as batch operated stages.

Ideally when the sorbing step is carried out continuously, or at least semi continuously, with a moving bed in which the ion exchange resin and the feed water move in counter current.

For example, the ion exchange resin may be discharged from a bottom region of an adsorber vessel (as a loaded exchange resin) and regenerated resin supplied to a top region of the adsorber vessel so the exchange resin moves downward in to the adsorber vessel. The feed water stream may flow in counter current to the direction of movement for the resin. Specifically, the feed water is supplied into the bottom region of the adsorber vessel and a treated water stream is discharged from a top region of the adsorber vessel.

The loaded resin may be airlifted from the bottom region of the adsorber vessel to a top region of the regenerator vessel and move downwardly so that the regenerated ion exchange resin is discharge from the bottom region of the regenerator vessel. The regenerating stream may be feed in counter current to the direction of movement for the exchange resin, that is to say, the regenerating stream may flow upwardly in the regenerator vessel.

The converting step may be carried out in a continuous stirred converter vessel in which the bioactive material is substantially retained and the brine loaded with nitrate is supplied into the converter vessel, and the recycle stream low in nitrate is discharged from the converter vessel. If required, top up bioactive agent may be added to the converter vessel on an as needs basis.

It is also possible that the sorbing, regenerating and converting steps may be a carried out in semi-continuous flow stages in which the flow of at least one of the streams or the exchange resin is temporary stopped for a period.

The sorbing, regenerating and converting steps may also be operated as a batch stages or carrousel stages. However counter current continuous flow stages are preferred for the sorbing and regenerating steps as this allows for continuous cycling and minimizes the amount of cleaning of the resin beads. For instance, batch and carrousel stages often require particles to be removed from the feed water stream prior to sorbing nitrate, and similarly, particles often need to be removed from the regenerating stream used in the desorbing step. The removal of particles can be performed using suitable filtration, however, when the feed water and ion exchange resin move in counter current in the sorbing step, the sorbing step has a cleaning function that can separate particles from the resin, thereby avoiding the need for a separate preliminary filtering step.

Similarly, when the regenerating stream and the ion exchange resin move in counter current, the regenerating step has a cleaning function that can separate the particles from the resin, thereby avoiding the need for a separate filtering step.

In any event as described above, ideally the process includes filtering the recycle stream to remove entrained particles and some dissolved minerals to reduce the chance of the recycle stream contaminating the regenerating stage.

An embodiment of the present invention also relates to a plant for treating feed water containing nitrates, the plant including:
an adsorber vessel for sorbing nitrate in a feed water stream onto an ion exchange resin, which changes the ion exchange resin into a loaded ion exchange resin and produces a treated water stream depleted in nitrate;
a regenerator vessel for regenerating the loaded resin by desorbing nitrate therefrom using a regenerating stream including a salt which changes the loaded ion exchange resin into a regenerated ion exchange resin for reuse in step i), and produces a brine stream high in nitrate;
a converter vessel for converting nitrate in the brine stream into molecular nitrogen gas with the assistance of a bioactive agent, which separates from the brine stream, and thereby forms a brine that can provide a recycle stream; and
a recycling line in which at least part of the recycle stream is directly or indirectly fed back to the regenerator stage.

The plant may also include any one or a combination of the features of the process described herein. For example, the plant may include a filter for filtering particles and some dissolved minerals or nutrients from the recycle stream prior to using the recycle stream as part of, or all of, the regenerating stream. Similarly, the process may include any one or a combination of the features of the plant described herein.

Another embodiment of the present invention relates to a process for treating feed water containing nitrate, the process includes the steps of:
contacting a feed water stream and an ion exchange resin to sorb nitrate and form a loaded ion exchange resin and produce a treated water stream depleted in nitrate;
desorbing nitrate from the loaded ion exchange resin using a regenerating stream including a salt which changes the loaded ion exchange resin into a regenerated ion exchange resin for reuse in step i), and produces a brine stream high in nitrate;
converting nitrate in the brine stream into molecular nitrogen gas with the assistance of a bioactive agent, the nitrogen gas separates to form a recycle stream; and
adding at least part of the recycle stream to the regenerating stream.

### BRIEF DESCRIPTION OF THE DRAWING

A preferred embodiment of the present invention will now be described with reference to the accompanying Figures which may be summarised as follows.

FIG. 1 is a block diagram of a process and plant according to a preferred embodiment for treating a feed water stream to produce a treated water stream in a single absorber vessel and is an example in which the regenerating step is conducted in a single regenerator vessel. Table 1 comprises compositional data of streams 10 to 22 as shown in FIG. 1 according to one example.

FIG. 2 is a block diagram of a process and plant according to another embodiment in which the present invention for treating a feed water stream to produce a treated water stream in a single absorber vessel and a regenerating step being conducted in two regenerator vessels. Table 2 comprises compositional data of streams 10 to 28 shown in FIG. 2 according to another example.

### DETAILED DESCRIPTION

The process includes supplying a feed water stream 10 into the bottom of an adsorber vessel for contacting the feed water stream 10 with a moving bed of an anion exchange resin. Any suitable type of an ion exchange resin can be used, such as a Type II strong base anion exchange resin. These resins are commercially available from (i) Purolite Corporation, for example, the resin sold under the trade name A520E, and (ii) Suzhou Bojie Resin Technology Co. Ltd, for example resins sold under the trade name BESTION BDX01.

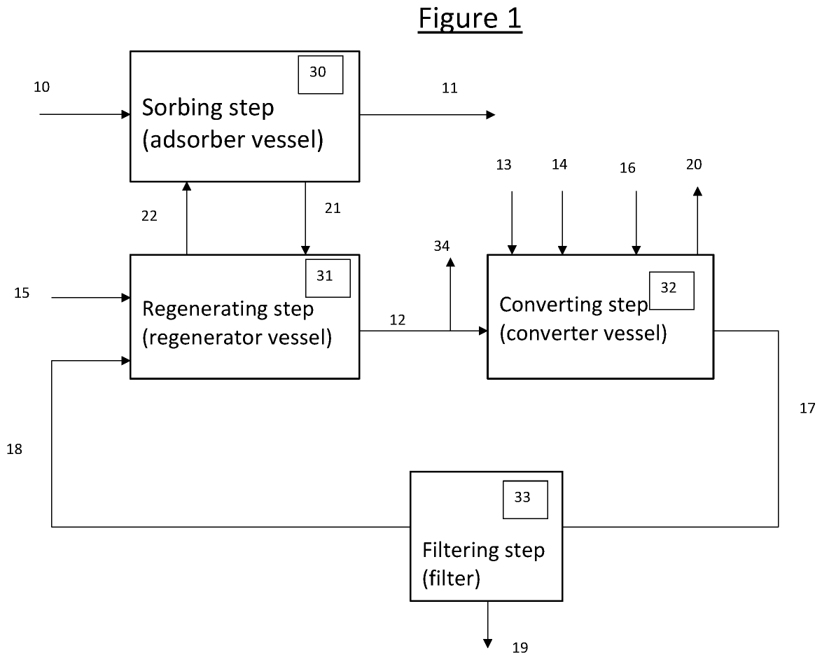

With reference to FIG. 1, the process includes a sorbing step 30 in which nitrate anions (NO₃⁻) are adsorbed onto the resin to form a loaded ion exchange resin. Although not shown in FIG. 1, ideally the ion exchange resin moves downwardly through the adsorber vessel and the feed water stream 10 flows upwardly through the adsorber vessel in counter current to the ion exchange resin in a continuous process. One of the advantages of the preferred embodiment is that the feed water stream 10, which according to the example shown in Table 1 is supplied to the sorbing step 30 at a flow rate of approximately 250 m³/hour having a nitrate (as N) concentration of 10 mg/L can produce a treated water stream 11 at a flow rate of 250 m³/hour having a nitrate (as N) concentration of less or equal to 1 mg/L. The nitrate (as N) concentration of feed water stream 10 is ideally low, for example, in the range of 5 to 30 mg/L and ideally approximately 10 mg/L or less. In other flowsheet the nitrate (as N) concentration can be in the hundreds of milligrams per litre.

A stream of loaded exchange resin 21 is discharged from the sorbing step 30. Stream 21 may be transferred by means of an airlift from the bottom of the adsorber vessel to the top region of the regenerator vessel in which regenerating step 31 is performed. The process includes regenerating the resin by desorbing or stripping the nitrate from the ion exchange resin as it moves downwardly in the regenerating vessel. A stream of regenerated ion exchange resin 22 is then airlifted back to the top of the adsorber vessel for reuse in the sorbing step 30. A regenerating stream, which includes at least part of a filtered recycle stream 18, is conveyed upwardly in the regenerator in counter current to the resin flow. If required, an additional make-up salt stream 15, containing chloride ions, and ideally in the form of an alkaline salt such as sodium chloride may also be supplied directly or indirectly into the regenerator vessel and form part of the regenerating stream. Although not shown in FIG. 1, a filtered recycle stream 18 and the make-up salt stream 15 may be mixed prior to being fed into the regenerator vessel 31. That is to say, the regenerating stream may comprise all of the filtered recycle stream 18, and some of the make-up salt stream 15, if and when the make-up salt stream 15 is used.

Although not shown in FIG. 1 or in Table 1, the process may include washing steps for washing the loaded resin stream 21 and/or the regenerated resin stream 22. However as described above, ideally the sorbing step 30 in the adsorber vessel, and the regenerating step 31 in the regenerator vessel are operated continuously as fluidised beds. In this instance, the resin being loaded flows downwardly in the sorbing step 30 (in the absorber vessel) in counter current to the feed water stream 10. The regenerated resin stream 22 flows downwardly in the regenerating step 31 (in the regenerator vessel) in counter current to the regenerating stream, comprising the recycle stream 18 and the make-up stream 15, when the latter is being used. In this situation, washing steps can be minimised, if not completely avoided.

When the feed water stream 10 has a flow rate of approximately 250 m³/hr, the adsorber vessel 30 will have an appropriate volume, such as cylindrical column having a diameter of approximately 2.4 m and a height of approximately 7 m. Similarly, the regenerating vessel may be a cylindrical column having a diameter of approximately 1.2 m and a height of approximately 7 m. The residence time of the ion exchange resin in the regenerating step 31 is therefore approximately half the residence time of the resin in the sorbing step 30.

A brine stream 12 is discharged from the regenerating step 31 and is fed to a converting step 32 in which a bioactive agent in the form of a bacteria known as Paracoccus denitrificans is used for denitrifying the brine stream 12. The bioactive agent is encapsulated in an inert body of polyvinyl alcohol (PVA). Ideally the inert body has an outside diameter of approximately 3 to 4 mm and a maximum thickness of ranging from 200 to 400 μm. The inert body has an inner porous matrix in which the bacteria is trapped and an outer shell that is porous to dissolved salts, nitrate, nutrients, minerals, and other dissolved materials including electron donating material such as carbonaceous material. Capsules of the bioactive agent may be made, for example, in accordance with the method described in International patent application number PCT/CZ2007/000015 (WO2007104268) in the name of Lentikat's., A.S., the full contents of which is incorporated into the present specification. Suitable capsules are also commercially available from Clean TeQ Water under the trade name BIOCLENS™.

The process includes converting the nitrate in the brine stream 12 into gaseous nitrogen by the bioactive agent. Nitrogen gas is represented by gas stream 20 leaving the converting step 32. To our surprise, the bioactive agent exhibits high nitrate degrading activity and longevity despite the salty conditions of the converting step 32. We have found that adding an electron donor in the form of a carbonaceous material, which is represented by stream 13 and may include ethanol or acetic acid, to assist the bioactive agent reducing of the nitrate to nitrogen. In addition, we have found that controlling the pH of the converting step by adding an acid, which is represented by stream 14, to maintain a pH of the converting step in the range of 6 to 8 favours the reduction of nitrate. Without wanting to be limited by theory, the bioactive agent can denitrify the brine stream by reducing nitrate (NO₃⁻) to nitrite (NO₂⁻) and the nitrite is further reduced to molecular nitrogen, which produces alkaline conditions in accordance with Equation 1 above. Furthermore, we have found that the longevity of the bioactive agent can be further enhanced by adding nutrients to the converting step 32. Suitable nutrients include phosphate and minerals. A separate stream of nutrients is not depicted in FIG. 1. If required, a make-up stream 16 of bioactive agent can be fed to the converting step 32. Capsules of the bioactive agent are retained in the converting step by the converter vessel have a grate or equivalent that holds the bioactive agent.

When the sulphate ion concentration in the feed water stream 10 is equal to less than 10 mg/L, the sulphate ion concentration in the brine stream 12 is in the range of 1,000 to 2,000 gm/L. We have found that at these conditions, the sulphate ion concentration in the brine stream 12 can be purged from the process via stream 34 split from the brine stream 12, or the sludge stream 19. Both stream 34 and the sludge stream 19 may be discharged periodically, variably, or even constantly at a slow rate.

As shown in Table 1, the bioactive agent converts the brine stream 12 at flow rate of 2.5 m³/hr having a nitrate (as N) concentration of 1140 mg/L to a raw recycle stream 17 at flow rate of approximately 2.625 m³/hr having a nitrate (as N) concentration of 10 mg/L. Controlling the pH of the converting step 32 may be carried out using any suitable acid. In a situation in which the acid also has chloride ions, the make-up salt stream 15 can be minimised, and possibly avoided altogether.

The raw recycle stream 17 may then be treated in a filtering step 33 by passed through a filter. The filtering step 33 may include either one or a combination of: i) physical filtration for separating particles, for example by means of passing through a sand filter; or ii) chemical filtration for removing minerals, nutrients, and other bioactive ingredients by passing through a bed of activated carbon. The filtering step 33 may separate entrained material that could have a detrimental impact on the regenerating step 31. A sludge stream 19 having a flow rate of approximately 0.125 m³/hour may be produced by the filtering step 33 when the process is operated in accordance with the compositions shown in Table 1.

It is possible that a split stream 34, including at least part of the brine stream 12, can be returned back to the start of the process and mixed with either one or a combination of the feed stream 10 and/or the treated water stream 11, without passing through the converting step 32. One of the reasons for doing this may be to provide a minimum level of nitrate in the treated water stream 11, or to control the salinity of the treated water stream 11. Another reason may be to reduce the load on the bioactive agent temporarily. The split stream 34 may be continuous having a constant or variable flow rate, or the split stream may be non-continuous in which it may fluctuate between no flow to flowing.

The process shown in FIG. 1 is particularly suitable when the concentration of the sulphate ions does not accumulate in the brine stream 12, the raw recycle stream 18 of the filtered recycle stream 18. Moreover, the process includes taking a purge stream such as sludge stream 19 or stream 34 in FIG. 1, and adding a make-up stream to the recycle loop, for example to at least one or a combination of the brine stream, recycle stream, the regenerating step or the converting step to control the concentration of sulphate. A manageable concentration of sulphate will depend on the economics and policy around handling the purge stream, including the cost for disposing of the purge stream and the impact the sulphate concentration has the activity of the bioactive agent. Depending on the concentration of the sulphate in the feed water stream 10 and the affinity of the resin for sulphate, we have also realised that the sulphate can be removed from the process by using another regenerating step.

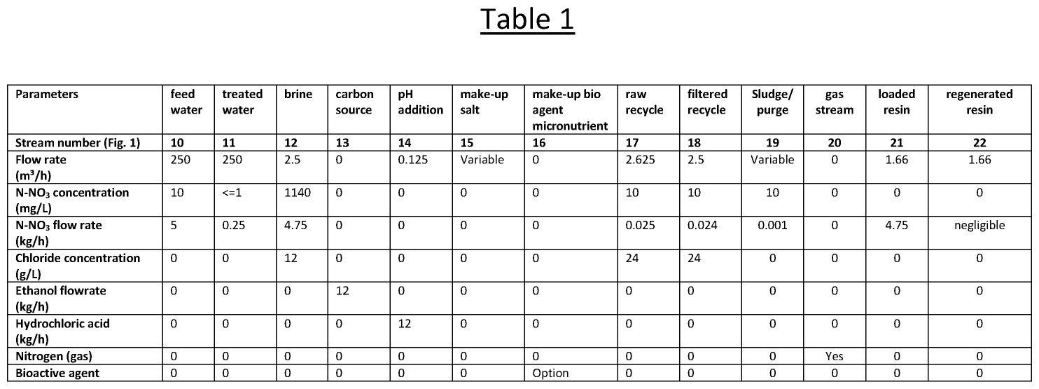

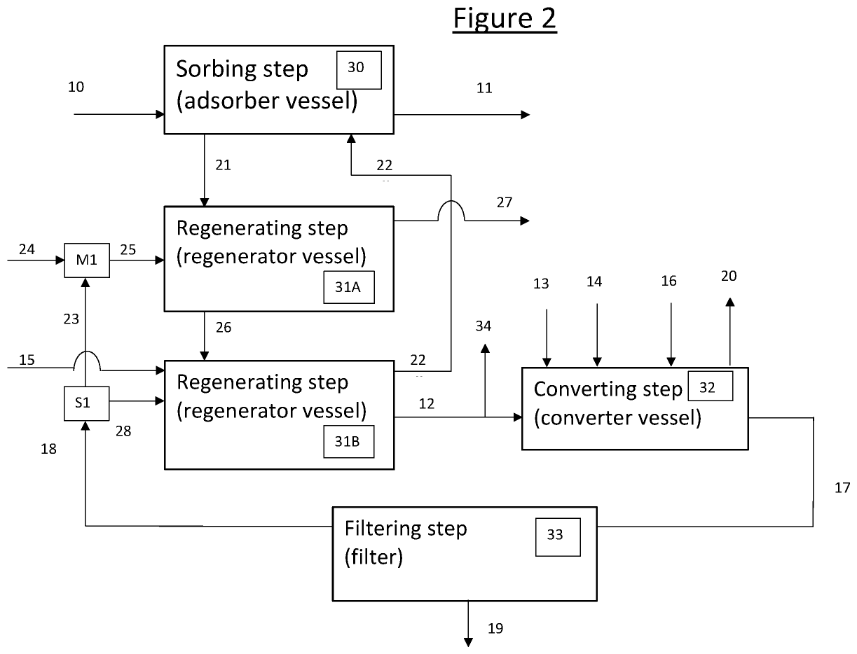

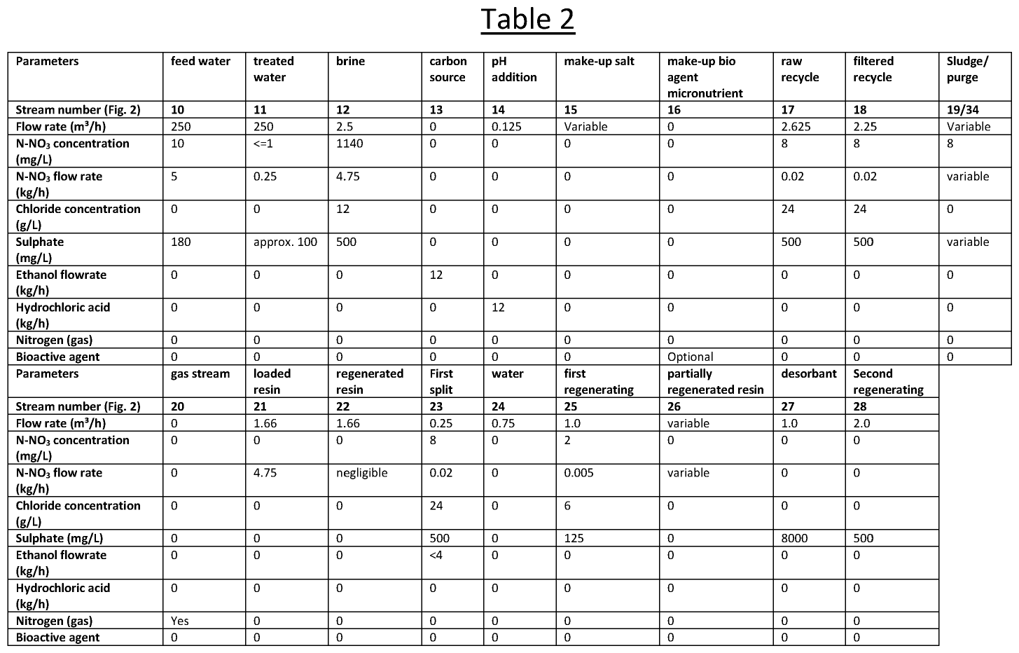

Specifically, FIG. 2 is an example of a process in which sulphate and nitrate are desorbed from the loaded resin in separate regenerating steps. It is envisaged that the process in FIG. 2 would be suitable when the sulphate ion concentration in the brine stream 12 equals or exceeds 2,000 mg/L. In our experience when the sulphate concentration in the brine stream 12 is approximately 2,000 mg/L or more, the sulphate ion concentration could become detrimental to the performance of the bioactive agent. By implementing the two stage regenerating steps, the concentration of sulphate can be readily reduced from these levels to a concentration, for example in the range of 800 to 200 mg/L, and suitably 500 mg/L. In addition to using separate regenerating steps, the process can still include controlling the concentration of the sulphate by taking a purge stream such as sludge stream 19 or stream 34 in FIG. 2, and adding a make-up stream to the recycle loop, for example to at least one or a combination of the brine stream, recycle stream, the regenerating step, or the converting step, to control the concentration of sulphate. In other words, the concentration of sulphate concentration in the brine stream will depend on many factors including the flows of sludge stream, stream 34, make-up stream 15, and operation of the regenerating steps.

As illustrated in FIG. 2, the process includes supplying a feed water stream 10 into the bottom of adsorber vessel for contacting the feed water stream 10 with a moving bed of an anion exchange resin. The ion exchange resin and the feed water stream 10 move in counter current in a continuous process. Any suitable type of ion exchange resin can be used, such as a Type II strong base anion exchange resin. Examples of these resins is provided in paragraph [0057].

Within the adsorber vessel, the process includes a sorbing step 30 in which nitrate anions (NO₃⁻) and sulphate anions are adsorbed onto the resin to form a loaded ion exchange resin. As shown in Table 2, the feed water stream 10 is supplied to the sorbing step 30 at a flow rate of approximately 250 m³/hour. The concentration of nitrate (as N) in the feed water stream 10 will naturally fluctuate, but by way of example, the water feed stream 10 may have a nitrate (as N) concentration of 10 mg/L and a sulphate ion concentration of greater than 10 gm/L, for instance 180 mg/L. A treated water stream 11 is discharged from the sorbing step 30 at a flow rate of 250 m³/hour having a nitrate (as N) concentration of approximately 1 mg/L.

A stream of loaded exchange resin 21 is discharged from the sorbing step 30. Stream 21 is transferred by means of an airlift from the bottom of the adsorber vessel to the top region of the regenerator vessel in which a first regenerating step 31A is performed. The first regenerating step 31A includes partially regenerating the resin by desorbing the majority of the sulphate from the ion exchange resin as it moves downwardly in the regenerating vessel using a first stripping stream 25 comprising a suitable alkali salt, such as a 1 wt % sodium chloride solution i.e., 6 g/L of chloride. A partially regenerated stream 26 of resin is then fed to the second regenerating step 31B in which a majority of the nitrate is desorb or stripped from the ion exchange resin as it moves downwardly in the regenerating vessel in counter current to a second regenerating stream. A stream of regenerated ion exchange resin 22 is then airlifted back to the top of the adsorber vessel for reuse in the sorbing step 30. The second regenerating stream comprises a split stream 28 of the filtered recycle stream 18 and, if required, an additional make-up salt stream 15, containing an alkali salt, such as sodium chloride. The make-up stream may also be supplied directly or indirectly into the regenerator vessel and form part of the second regenerating stream 31B. Although not shown in FIG. 2, the split stream 28 and the make-up salt stream 15 may be mixed prior to being fed into the regenerator vessel 31.

In addition, although not shown in FIG. 2 or in Table 2, the process may include washing steps for washing the loaded resin stream 21, the partially regenerated stream 26 and/or the regenerated resin stream 22. However as described above, ideally the sorbing step 30 in the adsorber vessel, and the first and second regenerating steps 31A and 31B in the regenerator vessel are operated continuously as fluidised beds. An advantage in the resin in the first and second regenerating steps 31A and 31B flowing in counter current to the first and second regenerating streams is that any washing steps can be minimised, if not completely avoided.

The adsorber vessel has a volume appropriate for handling the feed water stream 10 having flow rate of approximately 250 m³/hr. For instance, the adsorber vessel may be cylindrical column having a diameter of approximately 2.4 m and a height of approximately 7 m. Similarly, the regenerating vessel may comprise two cylindrical columns, each having a diameter of approximately 1.2 m and a height of approximately 7 m. The residence time of the ion exchange resin in the regenerating step 31A and 31B is therefore approximately the same as the residence time of the resin in the sorbing step 30.

A brine stream 12 is discharged from the regenerating step 31B and fed to a converting step 32 in which a bioactive agent in the form of a bacteria known as Paracoccus denitrificans is used for denitrifying the brine stream 12. The bioactive agent is encapsulated in an inert body of polyvinyl alcohol (PVA). Ideally the inert body has an outside diameter of approximately 3 to 4 mm and a maximum thickness of ranging from 200 to 400 μm. The inert body has an inner porous matrix in which the bacteria is trapped and an outer shell that is porous to dissolved salts, nitrate, nutrients, minerals, and other dissolved materials including electron donating material such as carbonaceous material. As mentioned above, capsules of the bioactive agent may be made, for example, in accordance with the method described in International patent application PCT/CZ2007/000015 (WO2007104268) in the name of Lentikat's., A.S., which is incorporated into the present specification. In addition, suitable capsules are also commercially available from Clean TeQ Water under the trade name BIOCLENS™.

The process includes converting the nitrate in the brine stream 12 into gaseous nitrogen by the bioactive agent. Nitrogen gas is represented by gas stream 20 leaving the converting step 32. To our surprise, the bioactive agent exhibits high nitrate degrading activity and longevity despite the salty conditions of the converting step 32. We have found that adding an electron donor in the form of a carbonaceous material, which is represented by stream 13, and may include ethanol or acetic acid can assist the bioactive agent reducing the nitrate to nitrogen. In addition, we have found that controlling the pH of the converting step by adding an acid, which is represented by stream 14, to maintain a pH of the converting step in the range of 6 to 8 favours the reduction of nitrate. Without wanting to be limited by theory, the bioactive agent can denitrify the brine stream by reducing nitrate (NO₃⁻) to nitrite (NO₂⁻) and nitrite can be further reduced to molecular nitrogen which produces alkaline conditions in accordance with Equation 1. Furthermore, we have found that the longevity of the bioactive agent can be further enhanced by adding nutrients to the converting step 32. Suitable nutrients include phosphate and other minerals. A separate stream of nutrients is not depicted in FIG. 2. If required, a make-up stream 16 of bioactive agent can be fed to the converting step 32 from time to time. Capsules of the bioactive agent are retained in the converting step by the converter vessel have a grate or equivalent that holds the bioactive agent

As shown in Table 2, the bioactive agent converts the brine stream 12 at flow rate of 2.5 m³/hr having a nitrate (as N) concentration of 1140 mg/L to a raw recycle stream 17 at flow rate of approximately 2.625 m³/hr having a nitrate (as N) concentration of 10 mg/L. Controlling the pH of the converting step 32 may be carried out using any suitable acid. In a situation in which the acid also has chloride ions, the make-up salt stream 15 can be minimised, and possibly avoided altogether.

The raw recycle stream 17 is treated in a filtering step 33 by passed through a filter. The filtering step 33 may include either one or a combination of: i) physical filtration for separating particles, for example by means of passing through a sand filter; or ii) chemical filtration for removing minerals, nutrients, and other bioactive ingredients by passing through a bed of activated carbon. The filtering step 33 may separate entrained material that could have a detrimental impact on the regenerating step 31. A sludge stream 19 having a flow rate of approximately 0.125 m³/hour is produced by the filtering step 33 when the process is operated in accordance with the compositions shown in Table 2. The filtered stream 18 is then used to form part of the second regenerated stream 28, optionally together with stream 15, for desorbing nitrate in the second regenerating step.

The filtered stream 18 is split into a first split stream 23 and the second regenerating 28 at S1. The first split stream 23 is diluted with water stream 24 at M1 to form the first regenerating stream 25 having an alkali salt concentration that is one quarter the concentration of filtered recycle stream 18. That is to say, when the filtered recycle streams 18 and 28 have a 4 wt % sodium chloride, and the first regenerating stream 25 has a concentration of approximately 1 wt % sodium chloride. As described above, the first regenerating stream 25 is used to desorb sulphate from the loaded resin in the first regenerating step 31A to produce a partially regenerated resin stream 26. A majority of the sulphate is selectively desorbed in the first regenerating step 31A, and a majority of the nitrate is selectively desorbed in the second regenerating step 31B. The first regenerating step 31A also produces a desorbant solution 27 comprising sulphate ions at a concentration of 8 mg/L at a flow rate of 1 m³/h which can then be disposed of as required.

Like the process described in FIG. 1, the process of FIG. 2 may also include split stream 34, including at least part of the brine stream 12, which can be returned back to the start of the process and mixed with either one or a combination of the feed stream 10 and/or the treated water stream 11, without passing through the converting step 32.

Those skilled in the art of the present invention will appreciate that many variations and modifications may be made to the preferred embodiment described herein without departing from the spirit and scope of the present invention.

In the claim which follows, and in the preceding description, except where the context requires otherwise due to express language or necessary implication, the word “comprise” and variations such as “comprises” or “comprising” are used in an inclusive sense, i.e. to specify the presence of the stated features but not to preclude the presence or addition of further features in various embodiments of the apparatus and method as disclosed herein.

1. A process of treating a feed water stream containing nitrate, the process includes the steps of:
(i) sorbing nitrate in the feed water stream onto an ion exchange resin, which changes the ion exchange resin into a loaded ion exchange resin and produces a treated water stream depleted in nitrate;
(ii) regenerating the loaded resin by desorbing nitrate therefrom using a regenerating stream including a salt which changes the loaded ion exchange resin into a regenerated ion exchange resin for reuse in step i), and produces a brine stream high in nitrate;
(iii) converting nitrate in the brine stream into molecular nitrogen gas with the assistance of a bioactive agent, the nitrogen gas separates from the brine stream, and thereby forms a brine that provides a recycle stream; and
(iv) adding at least part of the recycle stream to the regenerating stream.

2. The process according to claim 1, wherein the regenerated ion exchange resin is reused in the step of sorbing nitrates.

3. The process according to claim 1, wherein a majority of the recycle stream is added to the regenerating stream.

4. The process according to claim 1, wherein all of the recycle stream is added to the regenerating stream.

5. The process according to claim 1, wherein the step of sorbing nitrates onto the resin also sorbs sulphate onto the resin.

6. The process according to claim 5, wherein the process includes taking a purge stream from, and adding a make-up stream to, at least one or a combination of the brine stream and the recycle stream to control the concentration of sulphate in the brine stream and/or the recycle stream.

7. The process according to claim 6, wherein taking the purge stream and adding the make-up stream can control the sulphate ions accumulating in the brine stream and/or the recycle stream below a concentration of 2000 mg/L.

8. The process according to claim 5, wherein when the brine stream has a sulphate ion concentration above 2000 mg/L the regenerating step includes first and second regenerating steps.

9. The process according to claim 8, wherein the regenerating step includes a first regenerating step in which sulphate is desorbed from the loaded resin and a second regenerating step in which nitrate is desorbed from the resin after the first regenerating step.

10. The process according to claim 8, wherein the first regenerating step includes contacting the loaded resin with a first regenerating stream that has a first anion concentration at the start of the first regenerating step to form a partially regenerated resin, and the second regenerating step includes contacting the partially regenerated resin with a second regenerating stream that has a second anion concentration at the start of the second regenerating step to fully regenerate the resin, wherein the first anion concentration is less than the second anion concentration.

11. The process according to claim 8, wherein the first regenerating step includes diluting the first regenerating stream so that first anion concentration less than 50% of the concentration of the anion in the recycle stream.

12. The process according to claim 8, wherein of the first anion concentration of the first regenerating step is 25% of the recycle stream.

13. The process according to claim 8, wherein the process includes splitting the recycle stream into a first split stream and a second split stream, and the first split stream is diluted to reduce the concentration of the anion to form a first regenerating stream, and the first regenerating step includes contracting the first regenerating stream with the loaded resin to selectively desorb the majority of the sulphate from the resin, and form a partially regenerated resin.

14. The process according to claim 13, wherein the second regenerating stream includes contacting the second split stream with the partially regenerated resin to full regenerate the resin by desorbing the majority of the nitrate and any remaining sulphate ions.

15. The process according to claim 8, wherein the first regenerating stream has a sodium chloride concentration of approximately 1 wt % and the second regenerating stream has a sodium chloride concentration of approximately 4 wt %.

16. The process according to claim 1, wherein the feed water stream has a nitrate (as N) concentration in the range of the 1 to 1000 mg/L and the treated water stream may have nitrate (as N) concentration in the range of 0.1 to 0.9 mg/L.

17. The process according to claim 1, wherein the feed water stream has a nitrate (as N) concentration in the range of 6 to 20 mg/L and the treated water stream may have nitrate (as N) concentration in the range of 0.1 to 5 mg/L.

18. The process according to claim 1, wherein the step of converting nitrate in the brine stream into molecular nitrogen includes controlling pH so that the pH of the recycle stream is in the range of 5 to 8.

19. The process according to claim 1, wherein the step of converting the nitrate in the brine stream includes adding an acid to lower the pH of the recycle stream discharged from the converting step to a pH in the range of 5 to 8.

20. The process according to claim 1, wherein the step of converting the nitrate includes adding an electron donor to the brine stream and/or the converting step.

21. The process according to claim 5, wherein the electron donor is acetic acid which can be used either alone or in combination with one or more of: ethanol, glucose or sucrose.

22. The process according to claim 1, wherein the bioactive agent is Paracoccus denitrificans encapsulated in a body through which the brine stream can diffuse and entraps the bioactive agent.

23. The process according to claim 1, wherein the ion exchange resin is a strong base anionic resin.

24. A plant for treating feed water containing nitrate, the plant including:
an adsorber vessel for sorbing nitrate in a feed water stream onto an ion exchange resin, which changes the ion exchange resin into a loaded ion exchange resin and produces a treated water stream depleted in nitrate;
a regenerator vessel for regenerating the loaded resin by desorbing nitrate therefrom using a regenerating stream including a salt which changes the loaded ion exchange resin into a regenerated ion exchange resin for reuse in step i), and produces a brine stream high in nitrate;
a converter vessel for converting nitrate in the brine stream into molecular nitrogen gas with the assistance of a bioactive agent, which separates from the brine stream, and thereby forms a brine that can provide a recycle stream; and
a recycling line in which at least part of the recycle stream is directly or indirectly fed back to the regenerator stage.
